(19) United States
(12) Patent Application Publication
(10) Pub. No.: US 2008/0177656 A1
(43) Pub. Date: Jul. 24, 2008

(54) Client applications with third party payment integration

(75) Inventors: Ning Sun, Redmond, WA (US); Manoj K. Aggarwal, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/656,197

(22) Filed: Jan. 22, 2007

(51) Int. Cl. G06Q 20/00

(52) U.S. Cl. 705/39

(57) ABSTRACT

An application module enables users of a business application to incorporate a third party payment link into documents (e.g., invoices) that are created in an off-line environment. The third party payment link enables a receiver of an electronic copy of the document to navigate the link to a third party vendor's payment web site, where the receiver makes payment arrangements. In one embodiment, upon navigation of the link, transaction detail is automatically exported from the document into the third party vendor's on-line payment process. Transaction details can be downloaded from the third party payment service and, in one embodiment, are automatically accounted for within an accounting application.

### BACKGROUND

Currently, there are a variety of different e-commerce businesses that enable the sending and receiving of payments through the Internet. These services provide an electronic alternative to physical or paper payment methods such as currency transfers, checks and money orders. A well known business in this category is Paypal, Inc., a wholly owned subsidiary of eBay Inc. of San Jose, Calif.

Some e-commerce payment businesses provide third party payment services. In many cases, this type of service requires each new service consumer to first sign up for an account. Once an account has been established, the consumer can utilize the service to send and/or receive money online. The service acts as an intermediary between a payer and a payee. Money that is sent through the service is usually funded from the payer's account balance, a credit card, or a bank account. The service notifies a payment recipient (e.g., by email) when a payment has been received.

Many merchants that market products and services over the Internet refer their customers to commerce functionality offered by a third party. This referral is commonly embodied as a link to payment services offered through servers maintained by the third party (e.g., a payment button linked to an external web site hosted by a third party payment service, etc.). While interaction between the customer and the merchant's web site remains the primary means for carrying out substantive business, the customer may interact with the payment service to execute the actual financial transaction. In some cases, payment through the third party service is but one of several payment alternatives made available to the customer.

Unfortunately, for many merchants, providing a payment link for discovery by a customer in an on-line “check-out” environment is not the best match for the applicable business model. This is likely to be especially true for merchants whose customers request products and services outside of an Internet environment. For example, one who phones a company and hires them to mow their lawn may be unlikely to discover a third party payment link located on the company's web site. In this and many other scenarios, other means for presenting and effectively implementing third party payment options would be desirable.

The discussion above is merely provided for general background information and is not intended for use as an aid in determining the scope of the claimed subject matter.

### SUMMARY

An application module enables users of a business application to incorporate a third party payment link into documents (e.g., invoices) that are created in an off-line environment. The third party payment link enables a receiver of an electronic copy of the document to navigate the link to a third party vendor's payment web site, where the receiver makes payment arrangements. In one embodiment, upon navigation of the link, transaction detail is automatically exported from the document into the third party vendor's on-line payment process. In one embodiment, the application module provides functionality that enables a listing of payment information to be downloaded and integrated into the business application.

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter. Further, the claimed subject matter is not limited to implementations that solve any or all disadvantages noted in the background.

### BRIEF DESCRIPTION OF THE DRAWINGS

FIG. 1 is a schematic diagram of a commercial transaction environment.

FIG. 2 is a schematic diagram demonstrating one example of a specific interaction scenario that occurs within a commercial transaction environment.

FIG. 3A is a schematic diagram demonstrating a commercial interaction scenario that occurs within a commercial transaction environment.

FIG. 3B is a block flow chart demonstrating steps associated with a payment process.

FIG. 4 illustrates an example of a suitable computing system environment in which embodiments may be implemented.

### DETAILED DESCRIPTION

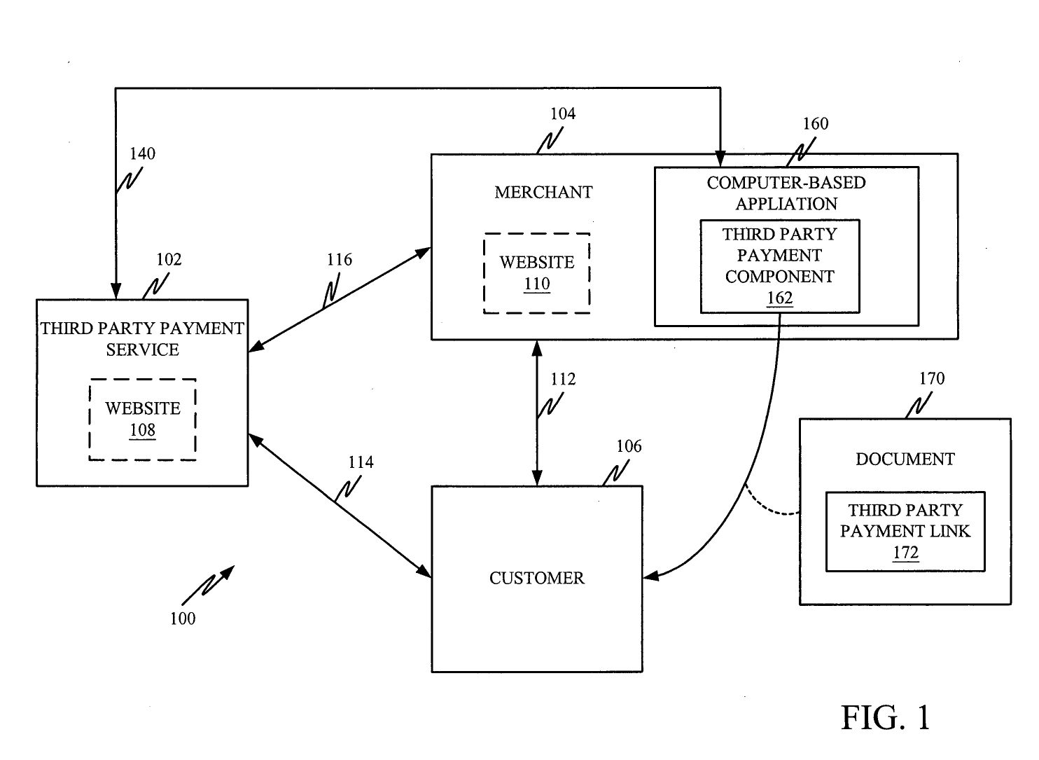

FIG. 1 is a schematic diagram of a commercial transaction environment 100. As is generally indicated by arrow 112, a customer 106 interacts with a merchant 104. This interaction may or may not occur through a web site 110 sponsored by merchant 104. Web site 110 is shown in dotted lines to represent the optional nature of that component.

Assumedly, a result of the customer-merchant interaction is that customer 106 desires to make a payment to merchant 104. In order to accomplish the payment, customer 106 illustratively interacts (arrow 114) with a third party payment service 102 in order to make payment arrangements. This interaction may occur through a web site 108 associated with service 102. Assuming agreement between service 102 and customer 106, as is generally indicated by arrow 116, service 102 makes payment to merchant 104 on behalf of customer 106. In one form or another, customer 106 reimburses or pre-pays the payment amount to service 102. Service 102 illustratively, though not necessarily, charges a fee to merchant 104 and/or customer 106 for acting as the intermediary.

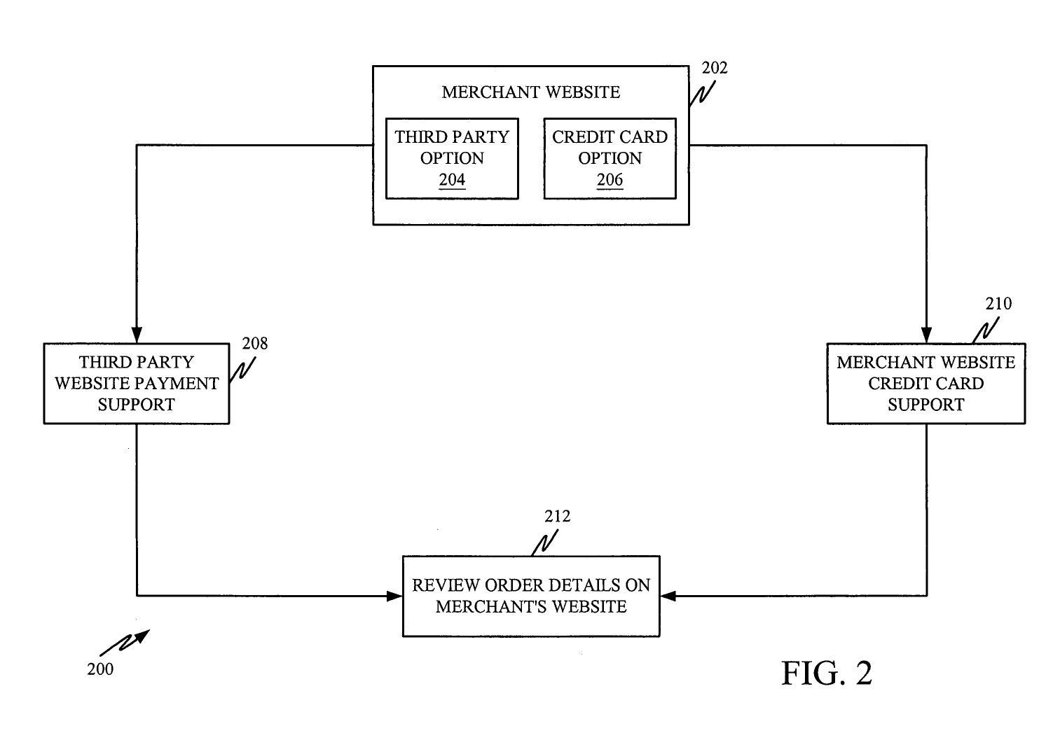

FIG. 2 is a schematic diagram demonstrating one example of a specific interaction scenario 200 that occurs within commercial transaction environment 100. In this case, it is assumed that customer 106 interacts with merchant 104 through the merchant's web site 110. It is also again assumed that customer 106 desires to submit a payment to merchant 104, for example, in exchange for goods or services. Consistent with box 202, customer 102 discovers, through interaction with web site 110, payment options 204 and 206. Option 204 represents payment through third party payment service 102. Option 206 represents payment through a credit card transaction process.

Assuming that customer 106 chooses the third party option 204, in accordance with block 208, the customer is directed to web site 108, which is sponsored and maintained by service 102. Customer 106 interacts with web site 108 so as to arrange for payment by service 102 of an appropriate payment to merchant 104. In accordance with block 212, following completion of payment processing on web site 108, the customer is redirected back to the merchant's web site 104 so that the customer can review and/or finalize order details. This return to the merchant's web site is sometimes an optional step in the progression or skipped all together, depending on a given implementation.

Assuming that customer 106 chooses credit card transaction option 206, in accordance with block 210, payment processing is illustratively facilitated directly through the merchant's web site 110. The order review process 212 also occurs through the merchant's web site. Thus, even though the credit card company could theoretically be perceived as a third party in the actual financial transaction, they are outside the scope of direct interaction in the payment scheme. Instead, the merchant is essentially relied upon to facilitate the transaction on behalf of the credit card company.

There are many reasons why payment through service 102 might be perceived as desirable over credit card payment or direct payment. For example, by using service 102, customer 106 might find it particularly convenient to make payments directly from a bank account rather than on a credit basis. Or, customer 106 might desire to avoid the hassle of entering credit card numbers each time a purchase is made. Or, customer 106 might perceive service 102 as a particularly secure payment alternative. For example, customer 106 might be attracted to the notion that merchant 104 will never see customer 106's bank account, credit card numbers, etc. Or, customer 106 might want to avoid hassles associated with obtaining and presenting checks or money orders. These are but a few examples of why customer 106 might choose payment though service 102 over other alternatives.

In many cases, a merchant will offer payment through a third party service because it is convenient from their perspective, from the perspective of their customers or from both perspectives. However, while interaction scenario 200 may work well for many merchants, it is not a perfect fit the every merchant's business model. Additional means for presenting and effectively implementing third party payment options would be desirable.

In that regard, an alternative interaction scenario for application within commercial transaction environment 100 will now be described. With reference to FIG. 1, a merchant illustratively utilizes a computer-based application 160. In one embodiment, not by limitation, application 160 is a computer-based system that is configured to provide merchant 104 with support for one or more business functions such as, but not limited to, purchasing, accounting, customer management, logistics management, etc. In one embodiment, the core functionality of application 160 (e.g., core business functionality) is configured for user operation in an “off-line” environment (e.g., outside of an Internet environment) though there still may be some integrated Internet-based functionality, such as the ability to facilitate the sending and/or receiving of email. In one embodiment, application 160 is a client-side application in that it is locally stored (or accessed remotely from a network location outside of the Internet).

Application 160 illustratively has access to a third party payment component 162. In one embodiment, not by limitation, component 162 is an add-in module for application 160 that supports third party payment functionality. For example, component 162 is illustratively configured to enable a user of application 160 to incorporate a third party payment link 172 into a document 170 (e.g., an invoice, a word processing document, finance charge documents, etc.). Application 160 supports the creation of document 170, as well as the transmission (e.g., by email) of the document to customer 106. When the customer 106 receives the document 170 and navigates the link 172, the customer is directed to web site 108, which is hosted by third party payment service 102. From there, the customer makes payment arrangements as appropriate to the circumstances (e.g., a payment related to the subject matter of document 170).

In one embodiment, document 170 and/or link 172 are configured such that, when customer 106 arrives at web site 108, details related to the underlying transaction are automatically provided to service 102. For example, in an example scenario where document 170 is an invoice, following navigation of link 172, information such as the invoice number, the invoice amount, item name(s) or description(s), shipping charge information, merchant identification, currency setting information, a note entered by customer 106, tax information and/or any other transaction information is automatically exported into a payment form or process hosted on web site 108. This exporting of information illustratively reduces the amount of information entry that customer 106 must do in order to effectuate a payment through service 102 (e.g., payment to merchant 104). However, prior to or following the described automatic export of transaction information, customer 106 may still be required to enter information as necessary for authentication (e.g., as necessary to access an account maintained with service 102).

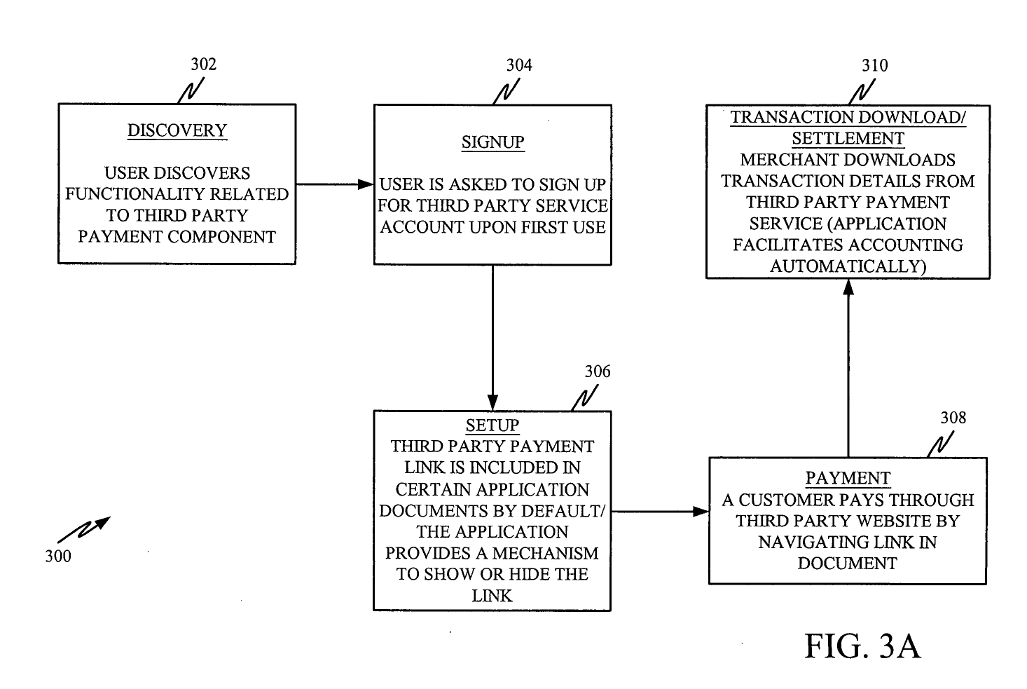

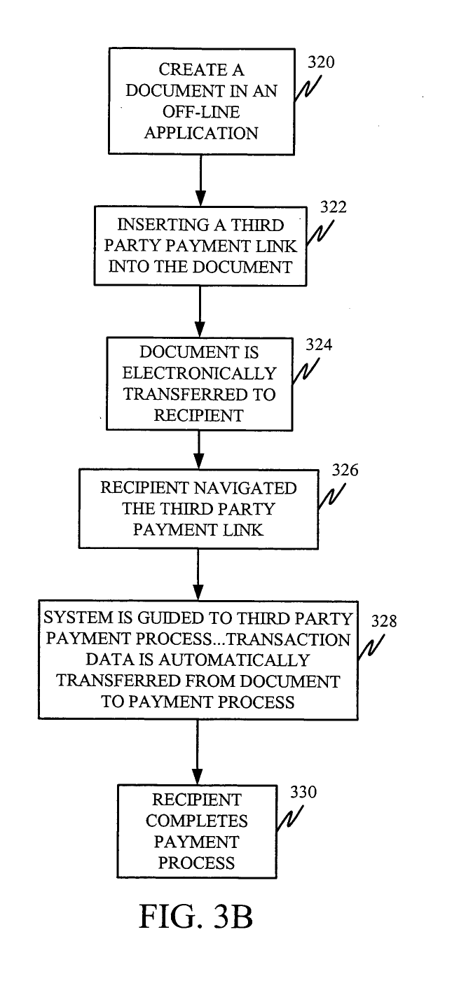

FIG. 3A is a schematic diagram demonstrating a specific interaction scenario as described, which is noted in the Figure as scenario 300. Interaction scenario 300 is appropriate for application within commercial transaction environment 100. Box 302 represents a discovery phase. In the discovery phase, a merchant user of application 160 discovers third party payment functionality associated with third party payment component 162. Assumedly, the user is interested in offering payment service 102 as a payment option to its customers.

Block 304 represents a signup phase. In the signup phase, the merchant user of application 160 establishes an account with payment service 102. In one embodiment, during the signup phase, the user is directed to a sign up process hosted on web site 108. In one embodiment, application 160 is configured to accessibly store account details (account username, etc.) following the signup process. Once the merchant user has established a business relationship with service 102, then the same account can be utilized subsequently by the same user and/or other users of application 162 (subject to security restrictions, etc.).

In one embodiment, during the setup phase, at least two different authentication mechanisms (e.g., passwords, logins, etc.) are established with the third party payment service. One of the mechanisms illustratively enables a user to access the merchant's general account functionality. The other mechanism enables a user to, as will be described in relation to phase 310, download and/or reconcile or settle payments made to the merchant account against certain invoices.

It is certainly possible that a given merchant might have an existing relationship with the third party payment service. In this case, the signup process may be simplified. However, depending on how a given system is set up, it still might be necessary for the merchant to perform certain additional registration steps. For example, it might be necessary for the merchant, user to establish an authentication mechanism for downloading and/or reconciling or settling payments made against certain invoices.

Block 306 represents a setup phase. During the setup phase, at least certain documents (e.g., invoices, finance charge documents, certain word processing documents, etc.) created with support from application 160 are provided with, on a default basis, a link to third party payment functionality. In one embodiment, application 160 (or component 160) provides the merchant user with a user interface component (e.g., a toolbar) that is configured to enable the third party payment link to be selectively removed from, or reasserted into, a given document. It should be noted that the default could just as easily be to not include the link in a document (e.g., the merchant has the option of adding the link as desired). Thus, whether a recipient of a document will be presented with the third party payment link depends upon the default or manual selection prior to transmission of the document. In one embodiment, application 160 and component 162 are configured such that a merchant user is able to embed a third party payment link in any document created with support of application 160.

In one embodiment, the user interface provided to the merchant user supports additional functionality related to third party payment links. For example, the user is illustratively provided with an option of choosing what the user interface associated with the payment link will look like (e.g., the user can choose any one of a variety of different button appearances). In another embodiment, a user is able to access help content related to functions associated with the third party payment integration. These are but two examples of additional functionality that can be integrated into application 160 in association with the third party payment functionality.

Box 308 represents a payment phase. In the payment phase, customer 106 has now received a document from merchant 104. The merchant user assumedly incorporated a third party payment link into the document (e.g., either by default or by choice). The customer navigates the third party payment link to web site 108, which is hosted by the payment service. The customer then interacts with web site 108 in order to arrange for payment to merchant 104.

As has been described, the system can be configured such that transaction details are automatically incorporated into the web site 108 payment process so as to reduce the amount of information entering required by customer 106. In one embodiment, the information exported by the document and/or payment link includes information saved on the merchant's system (e.g., merchant identification information, etc.) during the process of setting up a merchant account with the third party payment service. In one embodiment, the information exported by the document and/or payment link includes information contained within the document itself (e.g., the document is an invoice and the exported information includes invoice terms, etc.).

Box 310 represents a transaction download and, optionally, settlement phase. In this phase, a merchant user interacts with third party payment service 102 (e.g., through the Internet) such that relevant payment information can be downloaded. In one embodiment, this payment information is utilized by application 160 to settle third party payments against outstanding customer invoices. This especially makes sense in instances where payment was made against an invoice that itself was the document 170 having an imbedded third party payment link 172.

In one embodiment, web site 108 provides an interface from which a merchant user is able to manually download transaction data. For example, the user can download a transaction information file from site 108 in a logical and/or selectable format. In one embodiment, application 160 and/or module 162 provides functionality for facilitating the downloading of transaction data and/or the reconciling of transaction data against application data (e.g., off-line functionality that includes functionality to facilitate necessary retrieval of data from payment service over a network). In one embodiment, a downloading of transaction information is limited, for example, to transactions that have not been posted, or transactions not previously downloaded, etc.

In one embodiment, a user is provided with a downloading and reconciling wizard (e.g., part of application 160 and/or module 162) to facilitate the process of obtaining a transaction file from the payment service and integrating it into the business logic of application 160. One portion of the wizard illustratively facilitates merchant authentication. In this case, a merchant user must provide proper security credentials to demonstrate authorization to download transaction records. The security credentials may be the same or different than what is required for a merchant user to access a different portion of the third party payment system.

Another portion of the wizard illustratively provides a browse option that enables the merchant user to search for downloaded transaction files on the local system. Another portion of the wizard illustratively provides a display that includes a list of downloaded transactions that correspond to invoices sent with third party payment functionality. Another portion illustratively displays a list of all payments that have been made through the third party payment service for which corresponding invoices were not found. Another page illustratively displays a summary of settled invoices, payments and cash purchases created in response to downloaded transactions. In one embodiment, actual finalization and settlements of transactions requires user approval.

Those skilled in the art will appreciate that there are many technical approaches that can be taken to support the transaction download functionality. For example, the downloading process can be designed to leverage API's provided within the system architecture of the third party payment service system. Alternatively, a request URL provided by the third party payment system can be leveraged by the client system to download transaction information. Another option is to configure the client-side application so as to enable a merchant user to download transaction information (e.g., a log file) from the third party service's web site. The transaction information can then be uploaded into the product. These and other alternatives should be considered within the scope of the present invention.

Those skilled in the art will appreciate that the described features of application 160 may actually be an integration of multiple separate applications. For example, application 160 may be configured to facilitate document creation in conjunction with a separate application. In other words, documents created within application 160 may actually be templates within a separate word processing application, within a separate email application, etc. Thus, the functionality (e.g., the user interface components) for adding and/or removing a third party payment link could appear as part of application 160 itself or, alternatively, as part of an application utilized by application 160. These variations are to be considered within the scope of the present invention.

Thus, to summarize one embodiment, component 162 operates as a module for application 160 that is configured to support integration with a third party vendor's payment processing application. The module enables merchant user 104 to include a third party payment link as part of documents (e.g., invoices, finance documents, word processing documents, etc.) for which application 160 supports creation. This includes documents created through exportation to another application (e.g., exportation from a business application 160 to a word processing application, to an email application, etc.). The third party payment link enables the receiver of the invoice to go to the third party's vendor web site and make payments (e.g., payments to the invoice). In one embodiment, component 162 also provides functionality that enables payment transaction information to be downloaded from the third party vendor into application 160. In one embodiment, functionality is provided to facilitate at least partially automated settlement of transactions downloaded into an accounting system that is part of application 160.

FIG. 3B is a block flow diagram demonstrating one embodiment of specific steps associated with third party payment processing. Purely for illustrative purposes, the steps of FIG. 3B will be described in the context of a specific practical example. Those skilled in the art will appreciate that this is but one example of many potential examples within the scope of the present invention. The present invention is not limited to any related detail.

In accordance with the example, a merchant named Dave wants to increase the velocity of his transactions by allowing his customers to pay him using a third party on-line payment service. He downloads and installs a third party payment upgrade to a business application that he already utilizes to manage his accounting, inventory, etc. Following instructions, Dave completes a sign-up process so as to become a registered merchant customer of a particular third party on-line payment service.

Next, consistent with block 320 in FIG. 3B, within his business application, Dave creates an invoice for Chris, a customer of his that uses the same payment service that Dave just joined. After entering in information for the invoice, Dave clicks an “email” button. Next, Dave is presented with a properly formatted invoice in email format within an email application installed on Dave's machine. Consistent with block 322, by default, a third party payment button is included in the email. Dave notices a toolbar having an option where, if he desired, he could remove the third party payment button. Dave clicks “send” and, consistent with block 324, the invoice is sent via email to Chris.

Chris receives the email with the invoice. He notices the third party payment button at the bottom of the invoice. Consistent with block 326, Chris clicks on the button. He is taken to a payment form on an Internet web site sponsored by the associated third party payment service. Chris is pleased to see that, consistent with block 328, Dave's payment account information is already filled in, along with the amount of the invoice, the invoice number, the sales tax, and several other fields. Chris logs into his (or creates a) third party payment account and, consistent with block 330, makes a payment against the transaction associated with the invoice.

Later, Dave receives an email from the third party on-line payment service stating that the invoice has been partially but not completely paid. He logs into his third party payment account and verifies the information. Dave then utilizes a tool within his business application to download the details of the payment against the invoice. He is pleased when he discovers that the payment module to his business application facilitates the automatic entry of the partial payment against the invoice. The system walks Dave through the process of creating an invoice to be sent the following month for the remainder of the balance. The system allows Dave to schedule the invoice to be sent in 30 days by email with an incorporated third party on-line payment link.

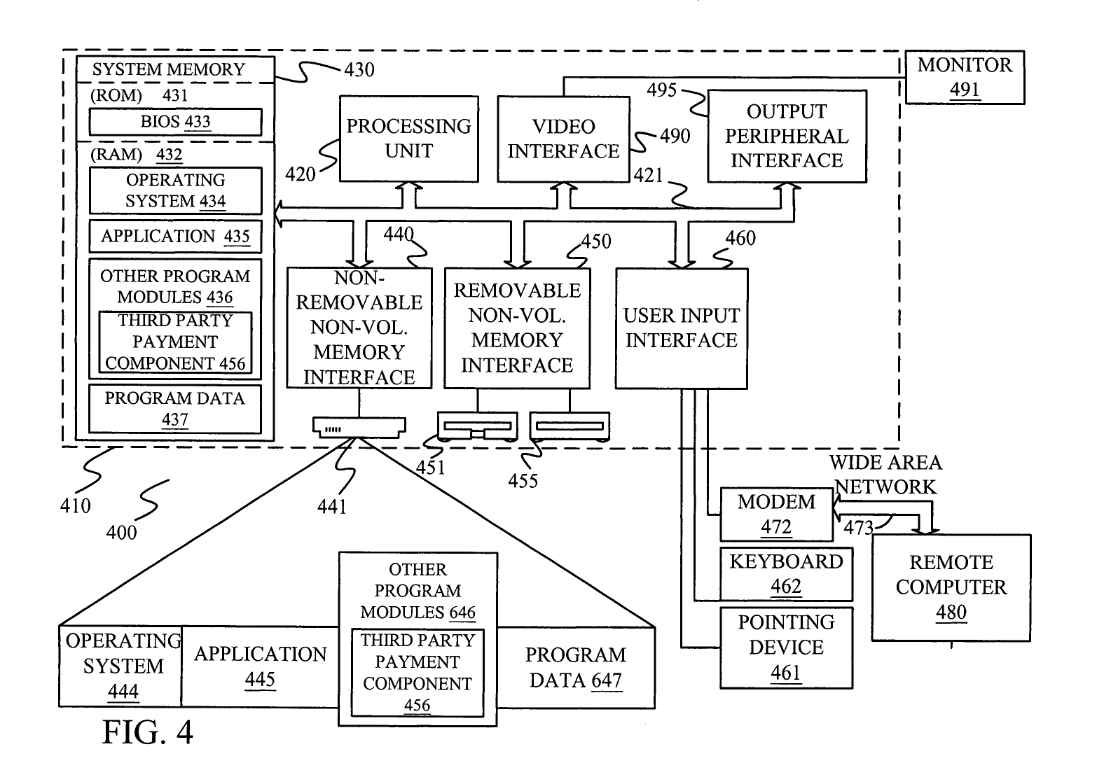

FIG. 4 illustrates an example of a suitable computing system environment 400 in which embodiments may be implemented. The computing system environment 400 is only one example of a suitable computing environment and is not intended to suggest any limitation as to the scope of use or functionality of the claimed subject matter. Neither should the computing environment 400 be interpreted as having any dependency or requirement relating to any one or combination of components illustrated in the exemplary operating environment 400.

Embodiments have been described herein in the general context of computer-executable instructions, such as program modules, being executed by a computer. Generally, program modules include routines, programs, objects, components, data structures, etc. that perform particular tasks or implement particular abstract data types. Embodiments can be practiced in distributed computing environments where tasks are performed by remote processing devices that are linked through a communications network. In a distributed computing environment, program modules can be located on both (or either) local and remote computer storage media including memory storage devices.

With reference to FIG. 4, an exemplary system for implementing some embodiments includes a general-purpose computing device in the form of a computer 410. Components of computer 410 may include, but are not limited to, a processing unit 420, a system memory 430, and a system bus 421 that couples various system components including the system memory 430 to the processing unit 420.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437. A third party payment component 456 is shown as one of the other program modules 436. Component 456 illustratively operates in conjunction with an application 435 in a manner similar to the relationship described above between components 162 and application 160 (FIG. 1).

The computer 410 may also include other removable/non-removable volatile/nonvolatile computer storage media. By way of example only, FIG. 4 illustrates a hard disk drive 441, a magnetic disk drive 451, and an optical disk drive 455. Other computer storage media could be included without departing from the scope of the present invention. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A third party payment component 456 is again shown as a program modules 436.

A user may enter commands and information into the computer 410 through input devices such as, but not limited to, a keyboard 462 and a pointing device 461, such as a mouse, trackball or touch pad. Other input devices (not shown) certainly should be considered within the scope of the present invention. Input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as, but not limited to, speakers or a printer (not shown), which may be connected through an output peripheral interface 495.

The computer 410 is operated in a networked environment using a logical connection to one or more remote computers, such as a remote computer 480. The remote computer 480 may be a personal computer, a hand-held device, a server, a router, a network PC, a peer device or any other common network node, and typically includes many or all of the elements described above relative to the computer 410. The logical connection depicted in FIG. 4 is wide area network (e.g., the Internet) 473, but another type of network could just as easily be substituted or added.

To support communication via the wide area networking environment, computer 410 includes a modem 472 or other means for establishing communications. The modem 472, which may be internal or external, may be connected to the system bus 421 via the user-input interface 460, or other appropriate mechanism. In a networked environment, program modules depicted relative to the computer 410, or portions thereof, may be stored in the remote memory storage device. It will be appreciated that the network connections and configurations shown are exemplary and other means of establishing a communications link between computers may be used.

In one embodiment, remote computer 480 is a computing system maintained by a third party payment service. Computer 410 is configured to communicate with computer 480, for example, to download transaction information, etc. Alternatively, computer 480 may be a computing system associated with a customer that, for example, receives invoices created in software application maintained on computer 410. Those skilled in the art will appreciate how the systems and interaction scenarios described in relation to FIGS. 1-3 are implemented in an environment such as that shown in FIG. 4.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for supporting financial transactions through a third party payment service, the method comprising:
creating a document in an offline application;
inserting a third party payment link within the document; and
electronically transferring the document to a customer.

2. The method of claim 1, wherein creating a document comprises creating a document related to a financial transaction.

3. The method of claim 1, wherein creating a document in an offline application comprises creating a document in an offline application having integrated third payment functionality that is part of an optionally installed upgrade to the application.

4. The method of claim 1, wherein inserting comprises providing a user interface component that is configured to insert or remove the third party payment link in response to user input.

5. The method of claim 1, wherein creating a document comprises creating a document that is configured to facilitate an export of data to a third party payment process after the customer has activated the third party payment link.

6. The method of claim 1, wherein creating a document comprises creating a document that is configured to facilitate an electronic transfer of data across a network from a computing device associated with the customer to a computing device associated with a third party payment service.

7. The method of claim 1, creating a document comprises creating a document that is configured to facilitate an electronic transfer of data, related to a financial transaction reflected in the document, from a computing device associated with the customer to a computing device associated with a third party payment service.

8. The method of claim 1, further comprising receiving, from a third party payment service, electronically transferred information related to a payment made by the customer through a payment process reached by a navigation of the third party payment link.

9. The method of claim 1, further comprising facilitating settlement of the payment against an invoice record that exists within the application.

10. The method of claim 9, wherein the document is a manifestation of the invoice record.

11. The method of claim 9, wherein facilitating settlement comprises providing a user interface to guide a user through a settlement process.

12. A document created within an off-line application and having an embedded third party payment link.

13. The document of claim 12, wherein the third party payment link is a selectable user interface component that is configured to be displayed on a computer screen when the document is displayed on a computer screen.

14. The document of claim 12, wherein a computer-implemented user selection of the third party payment link causes a web browser to be directed to a web site sponsored by a third party payment service.

15. The document of claim 12, wherein the third party payment link is linked to a web site where payment can be made for a financial transaction that is reflected in the contents of the document.

16. The document of claim 12, wherein the document is configured to facilitate an export of data to a third party payment process following activation of the third party payment link.

17. A computer-implemented method for maintaining financial records, the method comprising:
creating an invoice in an off-line application;
electronically transferring the invoice to a customer; and
receiving, from a third party payment service, electronically transferred information related to payment of a payment against the invoice.

18. The method of claim 17, further comprising facilitating settlement of the payment against a financial record maintained in the application.

19. The method of claim 18, wherein facilitating settlement comprises providing a user interface to guide a user through a settlement process.

20. The method of claim 18, wherein facilitating comprises collectively facilitating settlement of multiple payments against multiple invoices created in the off-line application.
